(19) United States
(12) Patent Application Publication
(10) Pub. No.: US 2024/0362816 A1
(43) Pub. Date: Oct. 31, 2024

(54) IDENTIFYING OBJECTS IN AN IMAGE USING ULTRA WIDEBAND WIRELESS COMMUNICATION DATA

(71) Applicant: MOTOROLA MOBILITY LLC, Wilmington, DE (US)

(72) Inventors: SANJEEV KUMAR POLURU VENKATA, BANGALORE (IN); JEEVITHA JAYANTH, BANGALORE (IN); SINDHU CHAMATHAKUNDIL, TRIVANDRUM (IN)

(21) Appl. No.: 18/309,822

(22) Filed: Apr. 30, 2023

(51) Int. Cl. G06T 7/70; H04N 23/67; H04N 23/69

(52) U.S. Cl. CPC G06T 7/70; H04N 23/675; H04N 23/69; G06T 2207/20132

(57) ABSTRACT

An electronic device, a method and a computer program product for identifying objects in an image. The method includes capturing a first image within a field of view of a first camera of an electronic device and receiving object data from a second electronic device. The method further includes determining based on the first object data, if the first image contains a first tagged object within the field of view. In response to determining that the first image contains the first tagged object within the field of view, the method further includes mapping, based on the first object data, the first tagged object to a first pixel location within the first image and generating first meta-data associated with the first image. The method further includes storing the first image with the first meta-data to a memory of the electronic device.

### BACKGROUND

### 1. Technical Field

The present disclosure generally relates to electronic devices with an integrated camera and in particular to an electronic device configured with an integrated camera and having ultra wideband wireless communication capability.

### 2. Description of the Related Art

Electronic user devices, such as cell phones, tablets, and laptops, are widely used for communication and data transmission. These user devices support various communication modes/applications, such as text messaging, audio calling and video calling. Most implementations of these user devices typically include one or more cameras that are used for taking pictures and videos and for supporting video calling or image content streaming. Many conventional electronic user devices have at least one front facing camera and one or more rear facing cameras. Various social media applications include image processing features that allow a user to manually edit and identify subjects of interest in images and photos. A user can manually edit images by cropping, resizing and zooming into areas of interest. A user can also manually select individuals at various positions in the photo and apply a tag with the individuals name or other identifying indicia.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2 is a block diagram of example contents of the system memory of the example electronic device of FIG. 1, according to one or more embodiments;

FIG. 3A is an example illustration of two electronic devices communicating with each other using integrated ultra wideband (UWB) communication transceivers, according to one or more embodiments;

FIG. 3B illustrates additional details of an image stored to the system memory of FIG. 2, according to one or more embodiments;

FIG. 4 is an example illustration of the electronic device of FIG. 1, being used to capture images within a field of view of a camera by a user of the electronic device, according to one or more embodiments;

FIG. 5A illustrates captured image content presented on a display of the electronic device of FIG. 1, according to one or more embodiments;

FIG. 5B illustrates the captured imaged content of FIG. 5A that has been automatically marked with a tagged object identifier and presented on the display of the electronic device, according to one or more embodiments;

FIG. 5C illustrates the captured imaged content of FIG. 5B displayed with a post capture processing parameter menu to apply an image effect and showing the selection, by a user, of one of the post capture processing parameters to be applied to the captured image, according to one or more embodiments;

FIG. 5D illustrates the captured imaged content of FIG. 5B that has been rendered with the selected image effect post capture processing parameter and presented on the display of the electronic device, according to one or more embodiments;

FIG. 5E illustrates the captured imaged content of FIG. 5B displayed with a post capture processing parameter zoom and focus icon for selection by a user, according to one or more embodiments;

FIG. 5F illustrates the captured imaged content of FIG. 5B rendered with the selection of the post capture processing parameter zoom and focus icon applied and presented on the display of the electronic device, according to one or more embodiments;

FIG. 5G illustrates the captured imaged content of FIG. 5B displayed with a post capture processing parameter tagged object deletion icon for selection by a user, according to one or more embodiments;

FIG. 5H illustrates the captured imaged content of FIG. 5B rendered with the selection of the post capture processing parameter tagged object deletion icon applied and presented on the display of the electronic device, according to one or more embodiments;

FIG. 6 depicts a flowchart of a method by which an electronic device identifies tagged objects and object locations in images, based on object data received via UWB communication from a second electronic device, according to one or more embodiments;

FIG. 7 depicts a flowchart of a method by which an electronic device marks images with object identifiers based on object data received via UWB communication, according to one or more embodiments;

FIG. 8 depicts a flowchart of a method by which an electronic device renders and displays images with at least one post capture processing parameter, according to one or more embodiments; and

FIG. 9 depicts a flowchart of a method by which an electronic device adjusts the zoom level and focal distance of an image to focus on a tagged object, based on location data received via UWB communication, according to one or more embodiments.

### DETAILED DESCRIPTION

According to one aspect of the disclosure, the illustrative embodiments provide an electronic device, a method, and a computer program product for identifying objects in an image by using object data received via ultra wideband communication. In a first embodiment, an electronic device includes an ultra wideband wireless communication transceiver, at least one camera, a display, and a memory having stored thereon an image identification module (JIM) for identifying objects in an image. The electronic device further includes at least one processor communicatively coupled to the ultra wideband wireless communication transceiver, the at least one camera, the display, and the memory. The at least one processor executes program code of the IIM, which enables the electronic device to capture a first image within a field of view of a first camera among the at least one camera and to receive, via the ultra wideband wireless communication transceiver, first object data from a second UWB-enabled electronic device located within the field of view. The at least one processor further determines, based on the first object data, if the first image contains a first tagged object within the field of view of the first camera. In response to determining that the first image contains the first tagged object within the field of view, the at least one processor maps, based on the first object data, the first tagged object to a first pixel location within the first image. The at least one processor generates first meta-data associated with the first image. The first meta-data contains at least the first pixel location of the first tagged object within the first image. The at least one processor stores the first image with the first meta-data to the memory. In one embodiment, the first object data is UWB data that is associated with a subject such as an individual.

According to a second embodiment of the disclosure, the method includes capturing, via a first camera of a UWB-enabled electronic device, a first image within a field of view of the first camera. The method further includes receiving, via the electronic device, first object data from a second UWB-enabled electronic device located within the field of view and determining, via at least one processor and based on the first object data, if the first image contains a first tagged object within the field of view of the first camera. In response to determining that the first image contains the first tagged object within the field of view, the method further includes mapping, based on the first object data, the first tagged object to a first pixel location within the first image and generating first meta-data associated with the first image. The first meta-data containing at least the first pixel location of the first tagged object within the first image. The method further includes storing the first image with the first meta-data to a memory of the electronic device.

According to an additional embodiment, a computer program product includes a computer readable storage device having stored thereon program code which, when executed by at least one processor of a UWB-enabled electronic device having an ultra wideband wireless communication transceiver, at least one camera, and a memory, enables the electronic device to complete the functionality of capturing a first image within a field of view of a first camera among the at least one camera and receiving first object data from a second electronic device located within the field of view. The program code further enables the at least one processor to determine, based on the first object data, if the first image contains a first tagged object within the field of view of the at least one camera. In response to determining that the first image contains the first tagged object within the field of view, the program code further enables the at least one processor to map, based on the first object data, the first tagged object to a first pixel location within the first image and to generate first meta-data associated with the first image. The first meta-data contains at least the first pixel location of the first tagged object within the first image. The program code further enables the at least one processor to store the first image with the first meta-data to the memory.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

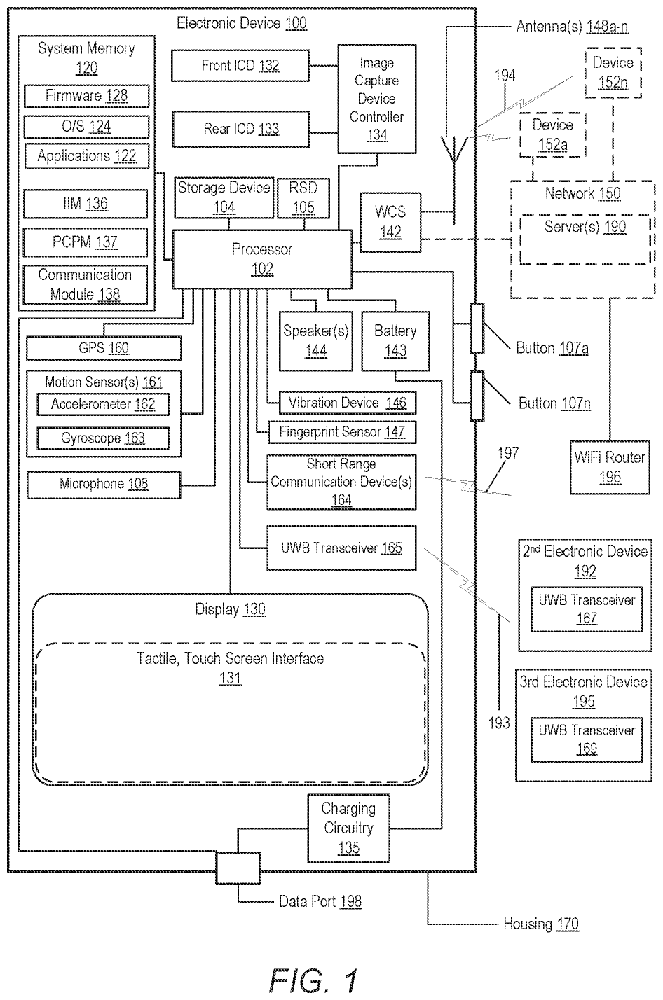

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer and a communication device, etc. It is appreciated that electronic device 100 can be other types of devices that include both at least one front facing camera and at least one rear facing camera and which supports both video and non-video communication with one or more second electronic devices. Electronic device 100 includes processor 102. As illustrated, processor 102 is communicatively coupled to storage device 104, system memory 120, input devices, introduced below, output devices, such as display 130, and image capture device (ICD) controller 134. Processor 102 can include processor resources such as a central processing unit (CPU), one or more graphics processing units (GPU) and one or more digital signal processors (DSP) that support computing, classifying, processing, and transmitting of data and information.

ICD controller 134 is coupled to and controls operations of image capturing devices, of which front ICD 132 and rear ICD 133 are presented. For simplicity, throughout the disclosure, the term image capturing device (referencing ICD 132/133) is utilized interchangeably to be synonymous with and/or refer to any one of front or rear facing cameras (132, 133). Front facing camera (or image capture device (ICD)) 132 are communicatively coupled to ICD controller 134, which is communicatively coupled to processor 102. ICD controller 134 supports the processing of signals from front facing camera 132. Front facing camera 132 can capture images that are within the field of view (FOV) of image capture device 132. While one front facing camera 132 is shown, electronic device 100 can have more than one front facing camera.

Electronic device 100 further includes a rear facing camera 133. Rear facing camera 133 is communicatively coupled to ICD controller 134, which is communicatively coupled to processor 102. ICD controller 134 supports the processing of signals from rear facing camera 133. While one rear facing camera is shown, electronic device 100 can have more than one rear facing camera.

According to one or more embodiments, ICD controller 134 performs or supports functions such as, but not limited to, selecting and activating an active camera from among multiple cameras, adjusting the camera settings and characteristics (e.g., shutter speed, f/stop, ISO exposure, zoom control, etc.) of the active camera, etc. ICD controller 134 can perform these functions in response to commands received from processor 102. In one or more embodiments, the functionality of ICD controller 134 is incorporated within processor 102, eliminating the need for a separate ICD controller. For simplicity in describing the features presented herein, the various camera selection, activation, and configuration functions performed by the ICD controller 134 are described as being provided generally by processor 102.

System memory 120 may be a combination of volatile and non-volatile memory, such as random access memory (RAM) and read-only memory (ROM). System memory 120 can store program code or similar data associated with firmware 128, an operating system 124, applications 122, image identification module (IIM) 136, post capture processing module (PCPM) 137, and communication module 138. IIM 136 includes program code that is executed by processor 102 to enable electronic device 100 to identify subjects and objects in captured images based on received ultra wide band data. PCPM 137 includes program code that is executed by processor 102 to enable electronic device 100 to modify and render captured images for display. Communication module 138 includes program code that is executed by processor 102 to enable electronic device 100 to communicate with other external devices and systems.

Although depicted as being separate from applications 122, IIM 136, PCPM 137, and communication module 138 may be each implemented as an application. Processor 102 loads and executes program code stored in system memory 120 including program code associated with applications 122, IIM 136, PCPM 137, and communication module 138.

In one or more embodiments, electronic device includes removable storage device (RSD) 105, which is inserted into an RSD interface (not shown) that is communicatively coupled via system interlink to processor 102. In one or more embodiments, RSD 105 is a non-transitory computer program product or computer readable storage device. RSD 105 may have a version of IIM 136 stored thereon, in addition to other program code. Processor 102 can access RSD 105 to provision electronic device 100 with program code that, when executed by processor 102, the program code causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touchscreen device, display 130 includes a tactile, touchscreen interface 131 that allows a user to provide input to or to control electronic device 100 by touching features presented within/below the display screen. Tactile, touch screen interface 131 can be utilized as an input device.

Electronic device 100 can further include data port 198, charging circuitry 135, and battery 143. Electronic device 100 further includes microphone 108, one or more output devices such as speakers 144, and one or more input buttons 107a-107n. Input buttons 107a-107n may provide controls for volume, power, and image capture device 132. Microphone 108 can also be referred to as audio input device 108. Microphone 108 and input buttons 107a-107n can also be referred to generally as input devices.

Electronic device 100 further includes wireless communication subsystem (WCS) 142, which is coupled to antennas 148a-148n. In one or more embodiments, WCS 142 can include a communication module with one or more baseband processors or digital signal processors, one or more modems, and a radio frequency (RF) front end having one or more transmitters and one or more receivers. Wireless communication subsystem (WCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150. In one embodiment, communication network devices 152a-152n contain electronic communication equipment to allow communication with electronic device 100.

Wireless network 150 further allows electronic device 100 to wirelessly communicate with second electronic device 192, and third electronic device 195 which can be similarly connected to wireless network 150 via one of network communication devices 152a-152n. In one or more embodiment, wireless network 150 can include one or more servers 190 that support exchange of wireless data and video and other communication between electronic device 100 and electronic devices 192 and 195.

Electronic device 100 further includes short range communication device(s) 164, which is communicatively coupled to processor 102. Short range communication device(s) 164 is/are low powered transceiver(s) that can wirelessly communicate with other devices. Short range communication device 164 can include one or more of a variety of devices, such as a near field communication (NFC) device, a Bluetooth device, and/or a wireless fidelity (Wi-Fi) device. Short range communication device 164 can wirelessly communicate with WiFi router 196 via communication signals 197. In one embodiment, electronic device 100 can receive internet or Wi-Fi based calls via short range communication device 164. In one embodiment, electronic device 100 can communicate with WiFi router 196 wirelessly via short range communication device 164. In an embodiment, WCS 142, antennas 148a-148n and short-range communication device(s) 164 collectively provide communication interface(s) of electronic device 100. These communication interfaces enable electronic device 100 to communicatively connect to at least one second electronic device 192 via at least one network. Wireless network 150 is communicatively coupled to wireless fidelity (WiFi) router 196. Electronic device 100 can also communicate wirelessly with wireless network 150 via communication signals 197 transmitted by short range communication device(s) 164 to and from WiFi router 196, which is communicatively connected to network 150.

According to one aspect of the disclosure, electronic device 100 further includes ultra wideband (UWB) transceiver 165, which is communicatively coupled to processor 102. UWB transceiver 165 is a low powered short range transceiver that can wirelessly communicate with other UWB transceiver. For example, second electronic device 192 can include a UWB transceiver 167 such that electronic device 100 and second electronic device 192 can wirelessly communicate via their respective UWB transceivers. Third electronic device 195 can include a UWB transceiver 169 such that electronic device 100 and third electronic device 195 can wirelessly communicate via their respective UWB transceivers. UWB transceiver 165 can use one or more of antennas 148a-148n or can use an internal antenna structure to communicate. UWB transceiver 165 can wirelessly communicate with external UWB transceivers 167 and 169 via communication signals 193. Ultra wideband is a technology for transmitting information across a wide bandwidth that allows for the transmission of signal energy without interfering with carrier signals (i.e., communication signals 194 to and from network communication devices 152a-152n). UWB transceivers 165, 167 and 169 can be used for precise location determination and position tracking, as will be described below.

Second electronic device 192 and third electronic device 195 can be a wide variety of electronic devices. Examples of such electronic devices include, but are not limited to, mobile devices, a notebook computer, a mobile phone, a digital camera, a smart watch, a tablet computer, a fitness tracker, a smart watch, an electronic tag and a communication device, etc. Importantly, the second electronic devices described herein are UWB-enabled second electronic devices.

Electronic device 100 further includes vibration device 146, fingerprint sensor 147, global positioning system (GPS) device 160, and motion sensor(s) 161. Vibration device 146 can cause electronic device 100 to vibrate or shake when activated. Vibration device 146 can be activated during an incoming call or message in order to provide an alert or notification to a user of electronic device 100. According to one aspect of the disclosure, display 130, speakers 144, and vibration device 146 can generally and collectively be referred to as output devices.

Fingerprint sensor 147 can be used to provide biometric data to identify or authenticate a user. GPS device 160 can provide time data and location data about the physical location of electronic device 100 using geospatial input received from GPS satellites.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. In one or more embodiments, the measurements of these various sensors can also be utilized by processor 102 in the determining of the context of a communication. Electronic device 100 further includes housing 170 that contains/protects the components of electronic device 100.

In the description of each of the following figures, reference is also made to specific components illustrated within the preceding figure(s). Similar components are presented with the same reference number.

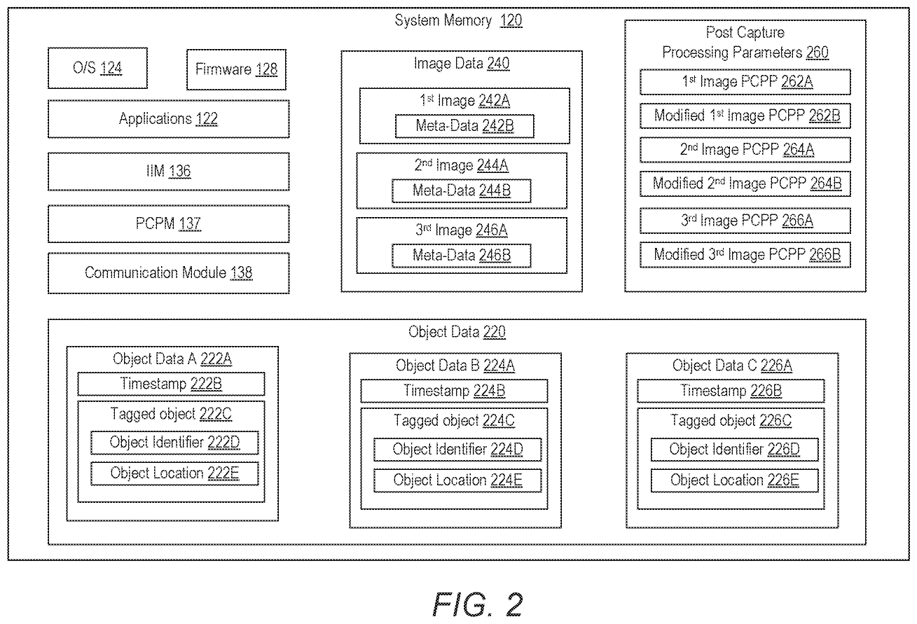

Referring to FIG. 2, there is shown one embodiment of example contents of system memory 120 of electronic device 100. System memory 120 includes data, software, and/or firmware modules, including applications 122, operating system 124, firmware 128, IIM 136, PCPM 137, and communication module 138.

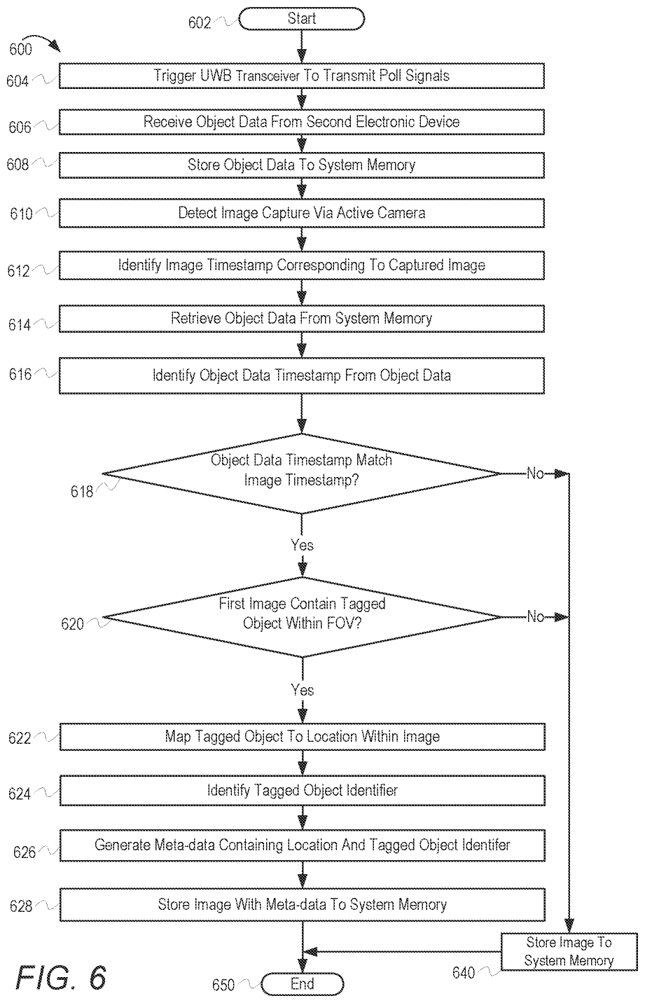

IIM 136 includes program code that is executed by processor 102 to enable electronic device 100 to perform various features of the present disclosure. In one or more embodiments, IIM 136 enables electronic device 100 to automatically identify subjects or objects in images captured within a field of view (FOV) by front facing camera 132 or rear facing camera 133. In one or more embodiments, execution of IIM 136 by processor 102 enables/configures electronic device 100 to perform the processes presented in the flowchart of FIG. 6, as will be described below.

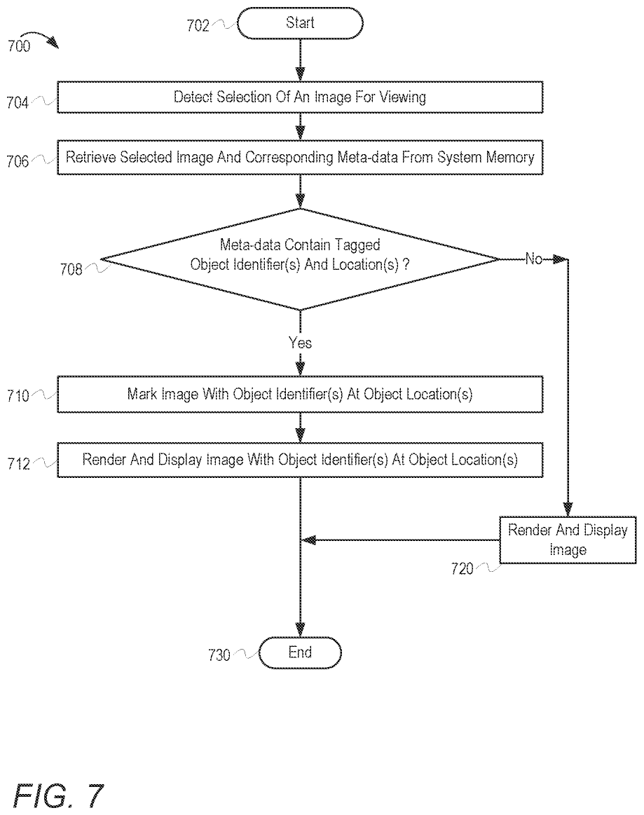

PCPM 137 includes program code that is executed by processor 102 to enable electronic device 100 to perform various features of the present disclosure. In one or more embodiments, PCPM 137 enables electronic device 100 to modify, render and display images captured by cameras 132 and 133. In one or more embodiments, execution of PCPM 137 by processor 102 enables/configures electronic device 100 to perform the processes presented in the flowcharts of FIGS. 7, 8 and 9 as will be described below.

Communication module 138 enables electronic device 100 to communicate with wireless network 150 and with other devices, such as second electronic device 192, via one or more of audio, text, and video communications. Communication module 138 supports various communication sessions by electronic device 100, such as audio communication sessions, video communication sessions, text communication sessions, communication device application communication sessions, or a dual/combined audio/text/video communication session.

System memory 120 further includes object data 220. Object data 220 comprises object data A 222A, object data B 224A and object data C 226A. While three sets of object data are shown, object data 220 can contain more or less than three sets of object data. UWB transceiver 167 and/or UWB transceiver 169 can periodically transmit object data 220 to electronic device 100. Accordingly, object data 220 can be periodically received by UWB transceiver 165 from UWB transceiver 167 of second electronic device 192 and/or from UWB transceiver 169 of third electronic device 195. Object data 220 contains various information and data about the second and third UWB-enabled electronic devices and the location of the second and third electronic devices.

As presented, object data A 222A comprises timestamp 222B and tagged object 222C, which includes object identifier 222D and object location 222E. Object data A 222A is received from UWB transceiver 167 of second electronic device 192 with a time corresponding to timestamp 222B. Object data B 224A comprises timestamp 224B and tagged object 224C which includes object identifier 224D and object location 224E. Object data B 224A is received from UWB transceiver 167 of second electronic device 192 with a time corresponding to timestamp 224B. Object data C 226A comprises timestamp 226B and tagged object 226C which includes object identifier 226D and object location 226E. Object data C 226A is received from UWB transceiver 169 of third electronic device 195 with a time corresponding to timestamp 226B.

According to the presented embodiment, timestamps 222B and 224B are generated by second electronic device 192 and correspond to the time that communication signal 193 (FIG. 1) is transmitted by UWB transceiver 167 (FIG. 1) to UWB transceiver 165. Timestamp 226B is generated by third electronic device 195 and correspond to the time that communication signal 193 is transmitted by UWB transceiver 169 (FIG. 1) to UWB transceiver 165. Object identifiers 222D and 224D identify second electronic device 192 and can identify subjects or users associated with second electronic device 192. Object identifier 226D identifies third electronic device 195 and can identify subjects or users associated with third electronic device 195.

In one embodiment, the object identifier can include the name of a user of second electronic device 192. In another embodiment, the object identifier can include the unique ID (e.g., MAC ID or Ser. No. or SIM ID or phone number) of second electronic device 192, which can then be used to identify the user of second electronic device 192. In another embodiment, second electronic device 192 can be an electronic tag that is mounted to a piece of equipment or a machine and can identify the equipment or machine based on a tag look-up database. Object locations 222E, 224E are the physical location of second electronic device 192 relative to electronic device 100. Object location 226E is the physical location of third electronic device 195 relative to electronic device 100. Object locations 222E, 224E and 226E each include a direction and distance that their respective electronic device is from electronic device 100.

System memory 120 further includes image data 240. Image data 240 contains images (e.g., still photographs or a continuous video) captured by at least one of front facing camera 132 or rear facing camera 133. Example image data 240 includes one or more images such as first image 242A, second image 244A, and third image 246A. First image 242A includes meta-data 242B, second image 244A includes meta-data 244B, and third image 246A includes meta-data 246B. Meta-data 242B, 244B and 246B contain information and data about their respective images. In an embodiment, meta-data 242B, 244B and 246B can be stored in an exchangeable image file format (EXIF) header of their respective image. In one embodiment, meta-data 242B, 244B and 246B contain camera settings, image metrics, UWB identity/location data and date/time information. Examples of camera settings include orientation, aperture, shutter speed, focal length, metering mode, and ISO speed information. Examples of image metrics include pixel dimensions, resolution, color space and file size. In one embodiment, meta-data 242B, 244B and 246B can further include at least a portion of object data 220. In an embodiment, if a tagged object (i.e., tagged object 222C) is detected in an image (i.e., first image 242A) by processor 102, then at least a portion of the object data ((i.e., object data A 222A) can be stored with the meta-data (i.e., meta-data 242B). Further details of the storage of the object data with the meta-data will be described below.

System memory 120 further includes post capture processing parameters 260. Post capture processing parameters 260 are parameters that are used during the processing, editing, rendering, and displaying of images. Example post capture processing parameters 260 comprise first image post capture processing parameters (PCPP) 262A, modified first image post capture processing parameters 262B, second image post capture processing parameters 264A, modified second image post capture processing parameters 264B, third image post capture processing parameters 266A and modified third image post capture processing parameters 266B. Rendering is the application of algorithms to image data to convert the image information into a viewable format on a display. Post capture processing parameters 260 can include various parameters such as editing features, display values, image effects, zoom level, focal distance, cropping area, image tags and removal of unwanted objects. Post capture processing parameters 260 can be used during the rendering process, after an image has been captured, to adjust the image values to fit a viewable area of a specific display. Post capture processing parameters 260 can also be used during the rendering process, after an image has been captured, to modify the displayed image based on automatically detected criteria such as a tagged object (i.e., tagged object 222C) in the captured image or based on a selected user input. In one or more embodiments, the post capture processing parameters (i.e., first image post capture processing parameters 262A) can be modified based on a user selection of a post capture processing parameter to be modified. The resulting modified first image post capture processing parameters 262B can be stored to system memory 120.

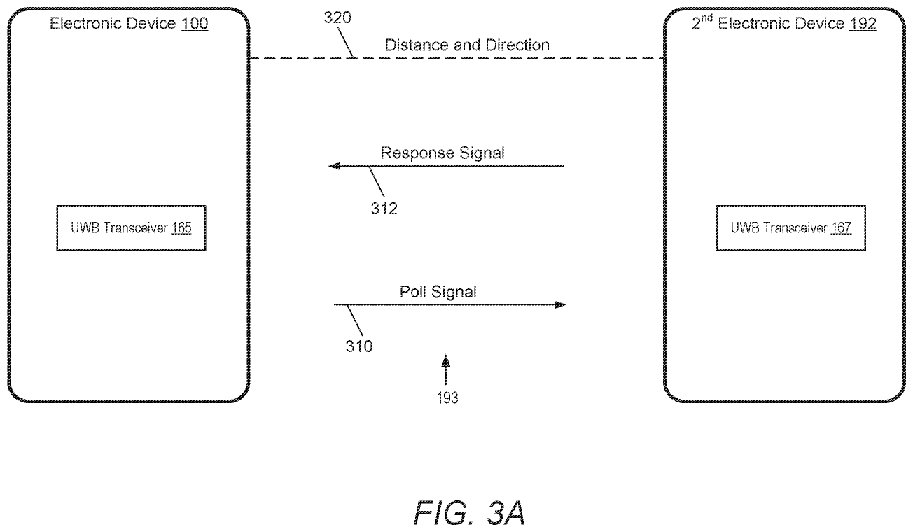

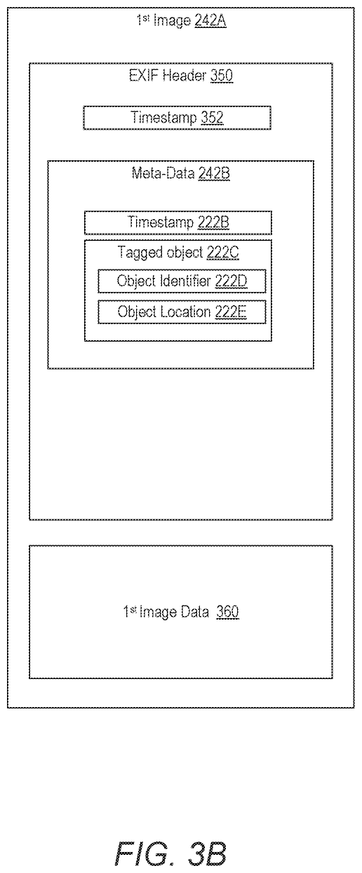

Turning to FIG. 3A, UWB transceiver 165 of electronic device 100 is shown wirelessly communicating with UWB transceiver 167 of second electronic device 192 via communication signals 193. In one embodiment, second electronic device 192 can include the same or similar components, as was previously described for electronic device 100. UWB transceiver 165 can transmit a poll signal 310 to UWB transceiver 167 and receive a response signal 312 from UWB transceiver 167. In one embodiment, response signal 312 contains object data A 222A, including timestamp 222B and tagged object 222C with an object identifier 222D and object location 222E.

UWB transceiver 165 can determine a distance and direction 320 between electronic device 100 and second electronic device 192 based on object data A 222A. UWB transceiver 165 can determine a distance between electronic device 100 and second electronic device 192 using timestamp 222B and knowing the time when poll signal 310 was transmitted. In one example embodiment, UWB transceiver 165 can determine a distance between electronic device 100 and second electronic device 192 using time of flight (ToF) measurements. UWB transceiver 165 can determine a direction that second electronic device 192 is located from electronic device 100 based on angle of arrival (AoA) techniques. UWB transceiver 167 can include an antenna array. UWB transceiver 167 can compare poll signal(s) 310 received from one portion of the antenna array with other poll signal(s) 310 received from another portion of the antenna array to determine the location of electronic device 192 relative to electronic device 100 in terms of elevation and azimuth.

FIG. 3B illustrates additional details of first image 242A stored to system memory 120. First image 242A comprises EXIF header 350 and first image data 360. EXIF is a standard that specifies formats for images and sound used by digital cameras. EXIF header 350 includes a timestamp 352 corresponding to the time that first image 242A was captured and meta-data 242B. In one embodiment, meta-data 242B contains camera settings, image metrics, and date/time information. In one embodiment, meta-data 242B can further include timestamp 222B, tagged object 222C, object identifier 222D and object location 222E. In an or more embodiments, when an image (i.e., first image 242A) is captured, if the image timestamp 352 matches a timestamp of the received object data (i.e., timestamp 222B) and a tagged object (i.e., tagged object 222C) is detected in an image (i.e., first image 242A) by processor 102, then timestamp 222B, tagged object 222C, object identifier 222D and object location 222E contained within the particular object data can be associated and stored with/within the meta-data (i.e., meta-data 242B).

FIG. 4 illustrates electronic device 100 being used by a user 410 to capture images within a field of view (FOV) 420 of rear facing camera 133 (FIG. 1). FOV 420 contains two subjects or objects including a person 412 throwing a ball 416 to a dog 414. Person 412 and dog 414 are within FOV 420 of the active camera (i.e., rear facing camera 133). Second electronic device 192 is shown in a pant pocket 430 of person 412. Person 412 is located at object location 222E and dog 414 is located at location 442. In one embodiment, second electronic device 192 can contain information that identifies the name of person 412 as being a registered user of second electronic device 192. The identity/name of person 412 can be transmitted from second electronic device 192 to electronic device 100 for use in identifying/tagging the name of the person 412 in captured images.

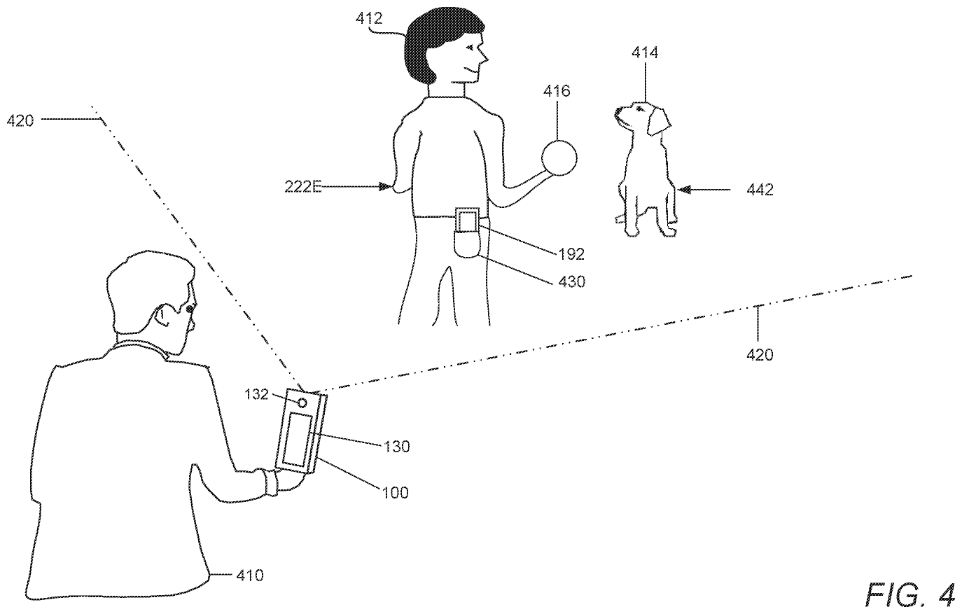

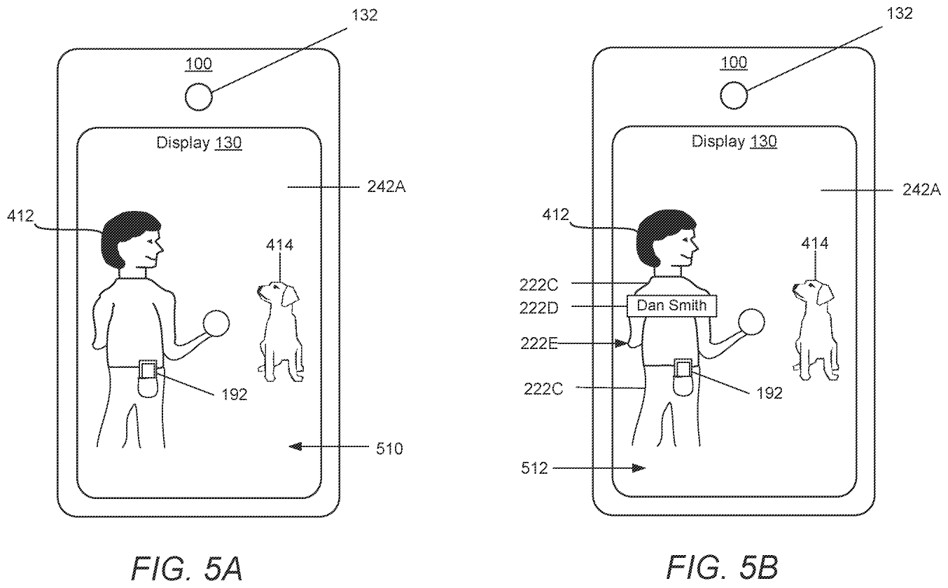

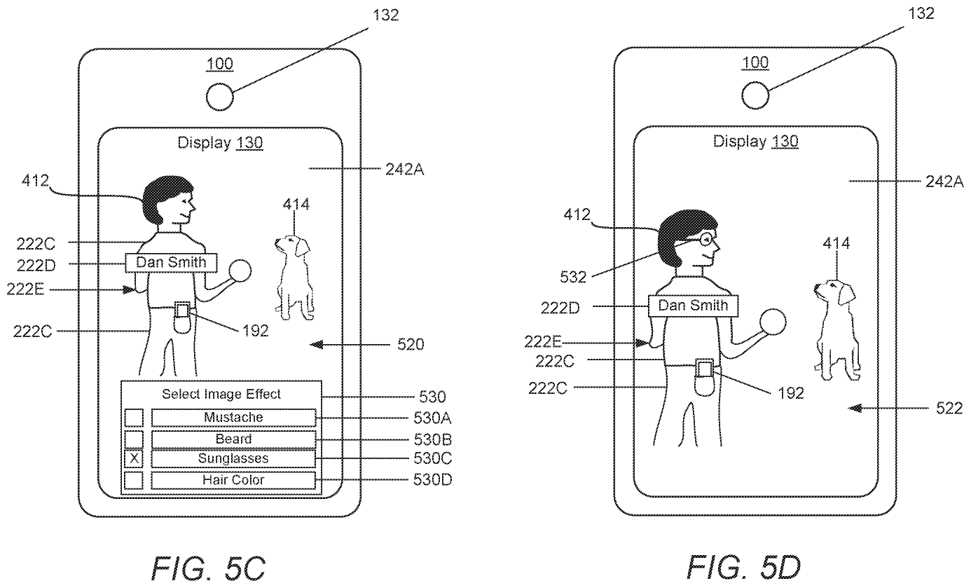

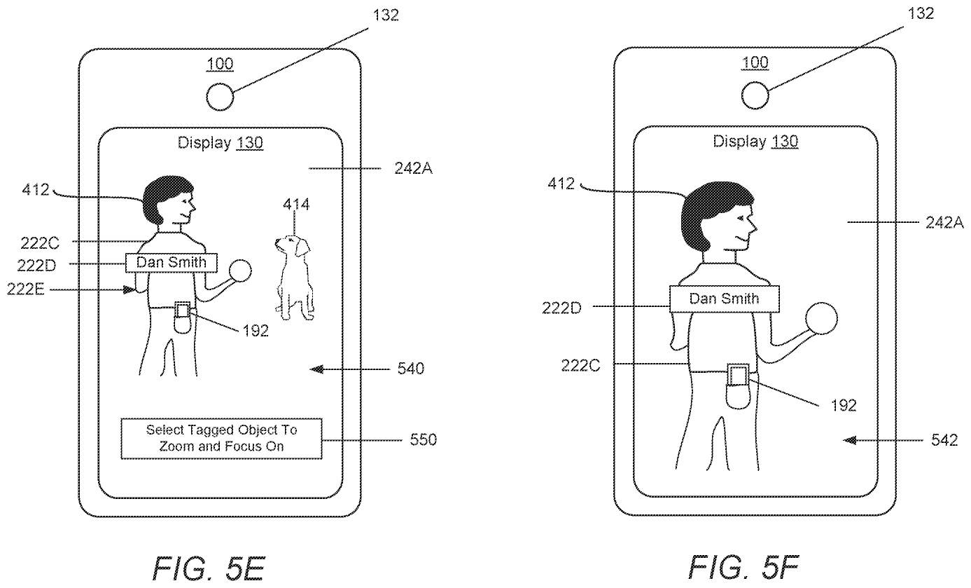

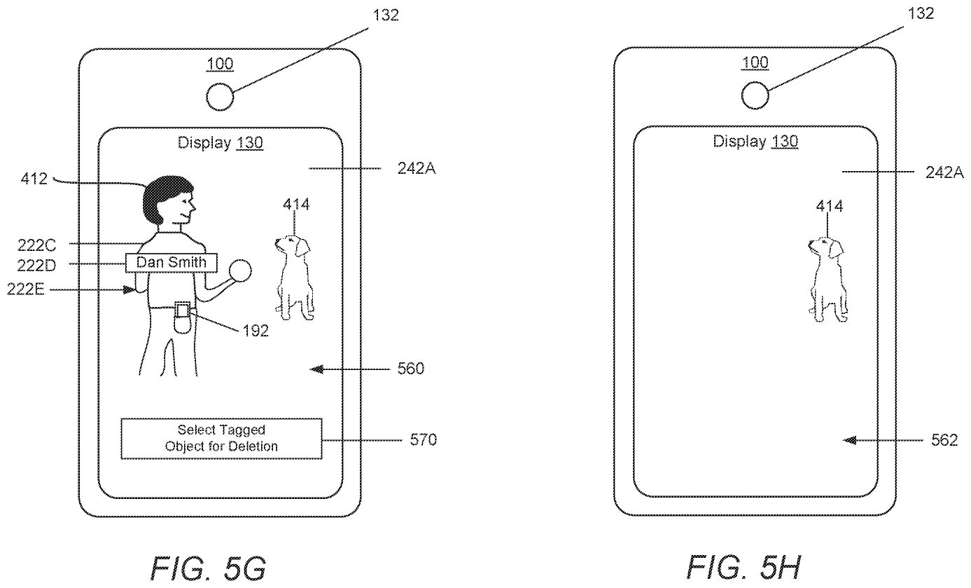

Turning to FIG. 5A, electronic device 100 is shown with the captured image of FIG. 4 presented on display 130. Specifically, electronic device 100 is illustrated with display 130 presenting an example GUI 510, which includes a captured image (i.e., first image 242A) of FOV 420 (FIG. 4) including person 412 and dog 414.

Referring to FIG. 5B, electronic device 100 is shown displaying the captured image of FIG. 4 after a tag identifying a tagged object has been applied to the captured image. In FIG. 5B, GUI 512 includes a captured image (i.e., first image 242A) of FOV 420 including person 412 and dog 414. GUI 512 further includes a tagged object 222C with an object identifier 222D placed at object location 222E.

In one embodiment, after electronic device 100 captures an image, electronic device 100 can determine if object data containing a tagged object 222C has been received from electronic device 192. In response to receiving the object data with a tagged object, electronic device 100 can determine a location 222E of the tagged object in the image and can mark the tagged object 222C with a tagged object identifier 222D at object location 222E in the image, as shown in FIG. 5B. The tagged object identifier 222D can correspond to the name of the registered user of second electronic device 100.

According to one aspect of the disclosure, IIM 136 enables electronic device 100 to capture, via rear facing camera 133, a first image (i.e., first image 242A) within a FOV 420 of the rear facing camera 133. Electronic device 100 receives, via UWB transceiver 165, object data A 222A from second electronic device 192. In one embodiment, second electronic device 192 is held by, carried on, or located in the vicinity of person 412. UWB transceiver 167 of second electronic device 192 is within communication range of UWB transceiver 165 of electronic device 100. Electronic device 100, via processor 102 determines, based on object data A 222A, if first image 242A contains a first tagged object (i.e., tagged object 222C) within FOV 420 of the rear facing camera 133. In response to determining that first image 242A contains a first tagged object (i.e., tagged object 222C) within FOV 420, processor 102 maps, based on object data A 222A, the first tagged object (i.e., tagged object 222C) to a first pixel location (i.e., object location 222E) within the first image 242A. Processor 102 further identifies, based on the object data A 222A, a first tagged object identifier 222D associated with the first tagged object. Processor 102 generates first meta-data 242B associated with the first image 242A. The first meta-data 242B contains the object identifier 222D and object location 222E of the tagged object 222C within first image 242A. Processor 102 stores the first image 242A with the first meta-data 242B to system memory 120 of electronic device 100.

According to another aspect of the disclosure, PCPM 137 enables electronic device 100 to determine if the first image 242A has been selected for viewing. In response to determining that the first image 242A has been selected for viewing, processor 102 retrieves the first image 242A and the first meta-data 242B corresponding to the first image and determines if the first meta-data 242B contains the object identifier 222D and the object location 222E of the first tagged object 222C within the first image 242A. In response to determining that the first meta-data 242B contains the object identifier 222D and the object location 222E of the first tagged object 222C within the first image 242A, processor 102 marks the first image 242A with the object identifier 222D at the object location 222E. Processor 102 renders and displays the first image 242A with the object identifier 222D at the object location 222E.

In one embodiment, IIM 136 and PCPM 137 enable electronic device 100 to automatically identify individuals or persons (i.e., tagged object 222C) in captured images (first image 242A) and to automatically mark the captured image with a tag (i.e., object identifier 222D) at the object location 222E in the captured image. The use of IIM 136 and PCPM 137 enable electronic device 100 to skip the time-consuming task of a user having to manually identify individuals in captured images and to manually input tag names and identifiers into the captured images.

According to one or more aspect of the disclosure, the processor of the electronic device performs or controls the performance of image capturing, object data detection and use, post-processing image manipulation, and image rendering at the electronic device. In addition to the features and functions involving the use of first object data, as introduced above, the at least one processor further identifies, based on the first object data, a first tagged object identifier associated with the first tagged object and modifies the first meta-data associated with the first image to generate modified first meta-data that includes the first tagged object identifier.

In one or more embodiments, the at least one processor further receives a plurality of object data for a first time period from the second electronic device. The plurality of object data each includes an object data time stamp specifying when the object data was generated. The at least one processor stores the plurality of object data for the first time period to the memory and identifies a first time stamp associated with the first image. The at least one processor determines if one stored object data time stamp substantially matches the first time stamp. In response to determining that one stored object data time stamp substantially matches the first time stamp, the at least one processor retrieves as the first object data, a specific one of the plurality of object data associated with the one stored object data time stamp.

In one or more embodiments, the at least one processor further determines if the first image has been selected for viewing. In response to determining that the first image has been selected for viewing, the at least one processor retrieves the first image and the first meta-data corresponding to the first image and determines if the first meta-data contains a first tagged object identifier and a first pixel location of the first tagged object within the first image. In response to determining that the first meta-data contains the first tagged object identifier and the first pixel location of the first tagged object within the first image, the at least one processor marks the first image with the first tagged object identifier at the first pixel location.

In one or more embodiments, the at least one processor further detects selection of a first post capture processing parameter of the first image for modification and generates a second post capture processing parameter of the first image at least partially based on the first meta-data. The at least one processor renders the first image based on the generated second post capture processing parameter. According to an implementation of the embodiments, the second post capture processing parameter comprises at least one of a zoom level, a focal distance, a cropping area, an image tag, an image effect and removal of an unwanted object.

In one or more embodiments, the at least one processor further retrieves at least one of a first zoom level and a first focal distance of the first image from the first meta-data and generates at least one of a second zoom level and a second focal distance of the first image based on the first pixel location of the first tagged object. The at least one processor adjusts at least one of the zoom level and the focal distance of the first image to the second zoom level and the second focal distance to focus on the first tagged object at the first pixel location.

In one or more embodiments, the at least one processor detects selection of an image effect for the first image and generates at least one post capture processing parameter for the selected image effect. The generated at least one post capture processing parameter is at least partially based on the selected image effect applied to the first tagged object identified by the first meta-data. The at least one processor renders the first image at least partially based on the generated at least one post capture processing parameter and displays the rendered first image on the display.

In one or more embodiments, the at least one processor displays the first image with the first tagged object identifier at the first pixel location and detects selection of the first tagged object for deletion in the first image. The at least one processor removes the first tagged object from the first image, renders the first image with the first tagged object removed and displays the rendered first image on the display.

FIG. 5C illustrates the captured imaged content of FIG. 4 displayed with object identifier 222D and an image effect menu 530. Specifically, electronic device 100 is illustrated with display 130 presenting an example GUI 520, which includes captured image (i.e., first image 242A) of FOV 420 including person 412 and dog 414. GUI 512 further includes a tagged object identifier 222D and image effect menu 530. Image effect menu 530 contains image effects that can be selected by a user of electronic device 100, e.g., via tactile touchscreen interface 131, to automatically apply various image effects to at least one tagged object (i.e., tagged object 222C) in a captured image. In the presented illustration, image effect menu 530 includes a mustache image effect 530A, a beard image effect 530B, a sunglasses image effect 530C and a hair color image effect 530D. It is understood that the presented effects are for example only and not intended to imply any limitations on the broader concepts of the disclosure. In FIG. 5C, the sunglasses image effect 530C has been selected as the image effect to be applied to the captured image.

With reference to FIG. 5D, electronic device 100 is shown displaying the captured imaged content of FIG. 4 that has been rendered with the selected image effect (i.e., sunglasses image effect 530C) and presented on display 130. In FIG. 5D, GUI 522 includes the captured image (i.e., first image 242A) including person 412 with added sunglasses 532, dog 414 and tagged object identifier 222D. The selected image effect of sunglasses 532 has been added to the face of person 412 shown on display 130.

According to one aspect of the disclosure, PCPM 137 enables electronic device 100 to detect selection of an image effect (i.e., sunglasses image effect 530C) for the first image 242A and to generate at least one post capture processing parameter (i.e., modified first image post capture processing parameters 262B) for the selected image effect. The generated at least one post capture processing parameter 262B is at least partially based on the selected image effect 530C applied to the first tagged object 222C identified by the first meta-data 242B. The first image 242A is rendered at least partially based on the generated at least one post capture processing parameter 262B and displayed on display 130. In one embodiment, PCPM 137 enables electronic device 100 to automatically apply image effects to individuals or persons that have been tagged with a tagged object identifier in displayed images.

FIG. 5E illustrates the captured imaged content of FIG. 4 displayed with object identifier 222D and a zoom/focus icon 550. Specifically, electronic device 100 is illustrated with display 130 presenting an example GUI 540, which includes the captured image (i.e., first image 242A) of FOV 420 including person 412 and dog 414. GUI 540 further includes a tagged object identifier 222D and zoom/focus icon 550. Zoom/focus icon 550, when selected by a user of electronic device 100, e.g., via tactile touchscreen interface 131, automatically zooms and focuses in on at least one tagged object (i.e., tagged object 222C) in a displayed image.

With reference to FIG. 5F, electronic device 100 is shown displaying the captured imaged content of FIG. 4 that has been rendered after zoom/focus icon 550 has been selected. In FIG. 5F, GUI 542 includes the captured image that has been zoomed in and focused on person 412 having the tagged object identifier 222D. After zoom/focus icon 550 has been selected, electronic device 100 can automatically zoom and focus in on a tagged object (i.e., tagged object 222C corresponding to person 412) in a displayed image.

According to one aspect of the disclosure, PCPM 137 enables electronic device 100 to retrieve at least one of a current zoom level and/or focal distance for first image 242A from first meta-data 242B and to detect selection of a zoom/focus icon 550. Electronic device 100 generates a new zoom level and/or focal distance (i.e., modified first image post capture processing parameters 262B) based on the object location 222E of the tagged object 222C. Electronic device 100 adjust/renders the first image 242A using at least one of the new zoom level and/or focal distance to focus on the tagged object 222C with object identifier 222D at the object location 222E. Electronic device 100 displays the zoomed and focused image on display 130.

FIG. 5G illustrates the captured imaged content of FIG. 4 displayed with object identifier 222D and a tagged object deletion icon 570. Specifically, electronic device 100 is illustrated with display 130 presenting an example GUI 560, which includes the captured image (i.e., first image 242A) including person 412 and dog 414. GUI 540 further includes a tagged object identifier 222D and tagged object deletion icon 570. Tagged object deletion icon 570, when selected by a user of electronic device 100, e.g., via tactile touchscreen interface 131, automatically deletes at least one tagged object (i.e., tagged object 222C) in a displayed image.

Referring to FIG. 5H, electronic device 100 is shown displaying the captured imaged content of FIG. 4 that has been rendered after the tagged object deletion icon 570 has been selected. In FIG. 5H, GUI 562 includes the captured image that has had the tagged object (i.e., tagged object 222C with object identifier 222D) removed or deleted leaving only dog 414 in the displayed image. After tagged object deletion icon 570 has been selected, electronic device 100 can automatically delete the tagged object (i.e., tagged object 222C corresponding to person 412) in the displayed image.

According to one aspect of the disclosure, PCPM 137 enables electronic device 100 to display first image 242A with the tagged object identifier 222D at the object location 222E and to detect selection of the tagged object (i.e., tagged object 222C corresponding to person 412) for deletion in the first image 242A. Electronic device 100 can remove tagged object 222C, including tagged object identifier 222D, from the image. Electronic device 100 can further render the image 242A with the first tagged object 222C removed and display the rendered image on display 130.

According to another aspect of the disclosure, PCPM 137 enables electronic device 100 to delete objects in first image 242A that do not have a tagged object identifier. Electronic device 100 can display first image 242A with the tagged object identifier 222D at the object location 222E and can detect selection of the tagged object (i.e., tagged object 222C corresponding to person 412) to keep in the first image 242A. Electronic device 100 can remove all other objects without tags (i.e., dog 414) and keep tagged object 222C (i.e., person 412) in first image 242A. Electronic device 100 can render the first image 242A with non-tagged objects deleted and display the rendered image on display 130.

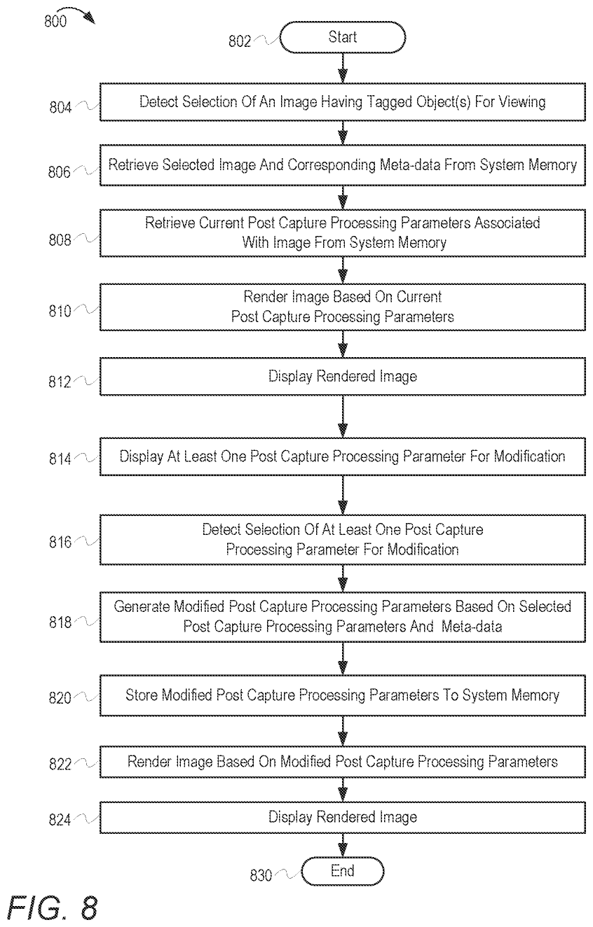

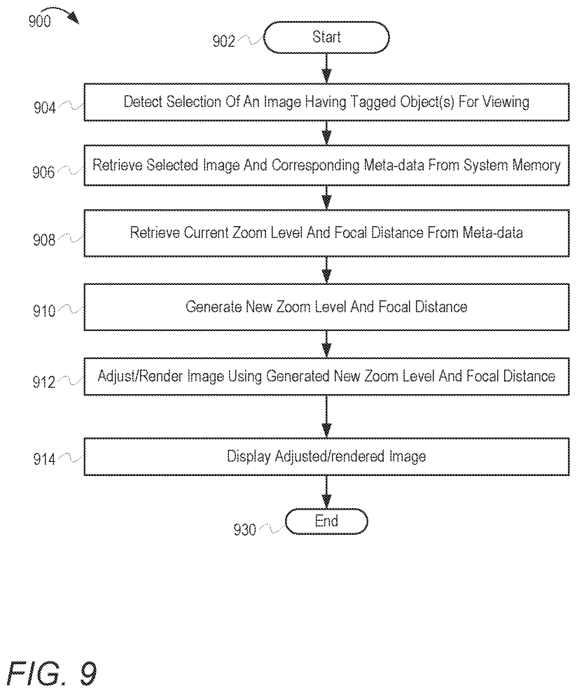

Turning now to the flow charts, FIG. 6 depicts method 600 by which electronic device 100 identifies tagged objects in captured images based on object data received, via UWB communication/transmission, from second electronic device 192. FIG. 7 depicts method 700 by which electronic device 100 marks captured images with tagged object identifiers received via UWB transmission of object data during image capture. FIG. 8 depicts method 800 by which electronic device 100 renders images having objects tagged or identified based on received UWB object data and displays the images with at least one post capture processing parameter. FIG. 9 depicts method 900 by which electronic device 100 adjusts a zoom level and focal distance of an image to focus on a UWB-located and tagged object. The description of methods 600, 700, 800 and 900 will be described with reference to the components and examples of FIGS. 1-5H.

The operations depicted in FIGS. 6, 7, 8, and 9 can be performed by electronic device 100 or any suitable electronic device that includes front and/or rear cameras and the one or more functional components of electronic device 100 that provide/enable the described features. One or more of the processes of the methods described in FIG. 6 may be performed by processor 102 executing program code associated with IIM 136. One or more of the processes of the methods described in FIGS. 7, 8 and 9 may be performed by processor 102 executing program code associated with PCPM 137.

With specific reference to FIG. 6, method 600 begins at start block 602. At block 604, processor 102 triggers UWB transceiver 165 to transmit poll signals 310. UWB transceiver 167 of second electronic device 192 can receive the poll signals 310 and transmit response signals 312 that contain object data A 222A. UWB transceiver 167 of second electronic device 192 is within communication range of UWB transceiver 165 of electronic device 100. Processor 102 receives object data A 222A from second electronic device 192 (block 606) and stores the object data A 222A to system memory 120 (block 608). In one embodiment, processor 102 can receive different object data 220 over a period of time from various electronic devices such as second electronic device 192 and third electronic device 195 (block 606) and can store the different object data 220 with multiple corresponding timestamps to system memory 120.

Processor 102 detects the capture, via rear facing camera 133, of at least one image (i.e., first image 242A) within a FOV 420 of the rear facing camera 133 (block 610). Processor 102 identifies timestamp 352 associated with the first image 242A (block 612) and retrieves object data A 222A from system memory 120 (block 614). Processor 102 identifies an object data timestamp (i.e., timestamp 222B) corresponding to object data A 222A (block 616). Processor 102 determines if one of the object data timestamps (i.e., timestamp 222B) substantially matches timestamp 352 associated with the first image 242A (decision block 618).

In response to determining that none of the object data timestamps (i.e., timestamp 222B) substantially matches timestamp 352 associated with the first image 242A, processor 102 stores the first image 242A to system memory 120 (block 640). Method 600 then ends at end block 650. In response to determining that one of the object data timestamps (i.e., timestamp 222B) does substantially match timestamp 352 associated with the first image 242A, processor 102, based on object data A 222A, determines if first image 242A contains a tagged object (i.e., tagged object 222C) within FOV 420 of the rear facing camera 133 (block 620).

In response to determining that first image 242A does not contain a tagged object (i.e., tagged object 222C) within FOV 420, processor 102 stores the first image 242A to system memory 120 (block 640). In response to determining that first image 242A contains a tagged object (i.e., tagged object 222C) within FOV 420, processor 102 maps, based on object data A 222A, the first tagged object (i.e., tagged object 222C) to a first pixel location (i.e., object location 222E) within the first image 242A (block 622). Processor 102 identifies, based on the object data A 222A, a first tagged object identifier 222D associated with the first tagged object (block 624). In one embodiment, processor 102 of electronic device 100 can automatically identify tagged objects (i.e., tagged object 222C) such as individuals or persons with an object identifier 222D at an object location 222E in captured images.

Processor 102 generates first meta-data 242B associated with the first image 242A (block 626). The first meta-data 242B contains the object identifier 222D and object location 222E (i.e., first pixel location) of the tagged object 222C within first image 242A. Processor 102 stores the first image 242A with the first meta-data 242B to system memory 120 of electronic device 100 (block 628). Method 600 ends at end block 650.

With specific reference to FIG. 7, method 700 begins at start block 702. At block 704, processor 102 detects selection of an image (i.e., first image 242A) for viewing. Processor 102 retrieves the first image 242A and the first meta-data 242B corresponding to the first image from system memory 120 (block 706). Processor 102 determines if the meta-data (i.e., meta-data 242B) contains the object identifier 222D and the object location 222E of the first tagged object 222C (decision block 708).

In response to determining that the first meta-data 242B does not contain the object identifier 222D and the object location 222E of the first tagged object 222C, processor 102 renders and displays the first image 242A without any tagged objects (block 720). Method 700 then ends at end block 650. In response to determining that the first meta-data 242B contains the object identifier 222D and the object location 222E of the first tagged object 222C, processor 102 marks the first image 242A with the object identifier 222D at the object location 222E (i.e., first pixel location) (block 710). Processor 102 renders and displays the first image 242A with the object identifier 222D at the object location 222E (block 712). Method 700 terminates at end block 730.

In one embodiment, processor 102 of electronic device 100 can automatically identify individuals or persons (i.e., tagged object 222C) in captured images (first image 242A) and automatically mark the captured image with a tag (i.e., object identifier 222D) at the object location 222E in the captured image. A user of electronic device 100 does not have to manually identify individuals in captured images and manually input tag names and identifiers into captured images.

Referring to FIG. 8, method 800 begins at start block 802. At block 804, processor 102 detects selection of an image (i.e., first image 242A) having at least one tagged object (i.e., tagged object 222C) for viewing. Processor 102 retrieves the first image 242A and the first meta-data 242B corresponding to the first image from system memory 120 (block 806). Processor 102 detects selection of a settings option or a menu option for post capture processing. Processor 102 retrieves the current post capture processing parameters for the first image 242A (i.e., first image post capture processing parameters 262A) from system memory 120 (block 808). In one embodiment, first image post capture processing parameters 262A can contain a set of parameters such as display values and attributes that allow rendering of first image 242A to be shown on display 130.

Processor 102 renders first image 242A with the first tagged object 222C based on the first image post capture processing parameters 262A (block 810) and displays the rendered image on display 130 (block 812). Processor 102 displays at least one post capture processing parameter for modification on display 130 (block 814). In one embodiment, the displayed post capture processing parameters can include at least one of display values, a zoom level, a focal distance, a cropping area, an image tag, an image effect and removal of an unwanted object. In an example embodiment, processor 102 displays image effect menu 530 (FIG. 5C) on display 130. Processor 102 detects selection of at least one post capture processing parameter for modification (block 816). In one example embodiment, a user can select a sunglasses image effect from image effect menu 530, e.g., via tactile touchscreen interface 131, as the at least one post capture processing parameter for modification. Processor 102 generates modified post capture processing parameters 262B for the first image 242A, at least partially based on the selected at least one post capture processing parameter applied to the first tagged object 222C identified by the first meta-data 242B (block 818). Processor 102 stores the modified post capture processing parameters 262B to system memory 120 (block 820). Processor 102 renders the first image at least partially based on the generated modified post capture processing parameters 262B (block 822) and displays the rendered image on display 130 (block 824). Method 800 ends at end block 830.

In another embodiment, the selected post capture processing parameter for modification of method 800 can be tagged object deletion icon 570. With continued reference to FIG. 8, and specifically beginning at block 814.

Processor 102 displays at least one post capture processing parameter for modification on display 130 (block 814). For the present embodiment, the displayed post capture processing parameter can be tagged object deletion icon 570 (FIG. 5G). Processor 102 detects the selection of tagged object deletion icon 570, e.g., via tactile touchscreen interface 131 (block 816). Processor 102 then generates modified post capture processing parameters 262B for the first image 242A with tagged object 222C removed from the captured image (block 818). Processor 102 stores the modified post capture processing parameters 262B to system memory 120 (block 820). Processor 102 renders the first image at least partially based on the generated modified post capture processing parameters 262B (block 822) and displays the rendered image without tagged object 222C visible on display 130 (block 824). Method 800 terminates at end block 830.

According to one aspect of the disclosure, first image data 240 with meta-data 242B and modified post capture processing parameters 262B can be used by or applied to presenting images within other applications such as social media applications, texting applications, and photo sharing applications. In one embodiment, electronic device 100 can automatically apply tags (i.e., object identifier 222D) to identified objects in captured images. In another one embodiment, electronic device 100 can automatically apply selected post capture processing parameters (i.e., modified post capture processing parameters 262B) to objects that have been identified in a captured image.

Referring to FIG. 9, method 900 begins at start block 902. At block 904, processor 102 detects selection of an image (i.e., first image 242A) having at least one tagged object (i.e., tagged object 222C) for viewing. Processor 102 retrieves the first image 242A and the first meta-data 242B corresponding to the first image from system memory 120 (block 906). Processor 102 retrieves at least one of a current zoom level and/or focal distance for first image 242A from first meta-data 242B (block 908).

Processor 102 generates a new zoom level and/or focal distance based on the object location 222E of the tagged object 222C (block 910). Processor 102 adjust/renders the first image 242A using at least one of the new zoom level and/or focal distance to focus on the tagged object 222C (with or without object identifier 222D) at the object location 222E (block 912). Processor 102 displays the zoomed and focused image on display 130 (block 914). Method 900 terminates at end block 930.

In the above-described methods of FIGS. 6, 7, 8 and 9, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
an ultra wideband wireless communication transceiver;
at least one camera;
a display;
a memory having stored thereon an image identification module (IIM) for identifying objects in an image; and
at least one processor communicatively coupled to the ultra wideband wireless communication transceiver, the at least one camera, the display, and the memory, the at least one processor executing program code of the IIM, which enables the electronic device to:
capture a first image within a field of view of a first camera among the at least one camera;
receive, via the ultra wideband wireless communication transceiver, first object data from a second electronic device located within the field of view;
determine, based on the first object data, if the first image contains a first tagged object within the field of view of the first camera;
in response to determining that the first image contains the first tagged object within the field of view, map, based on the first object data, the first tagged object to a first location within the first image;
generate first meta-data associated with the first image, the first meta-data containing at least the first location of the first tagged object within the first image; and
store the first image with the first meta-data to the memory.

2. The electronic device of claim 1, wherein the at least one processor:
identifies, based on the first object data, a first tagged object identifier associated with the first tagged object; and
modifies the first meta-data associated with the first image to generate modified first meta-data comprising the first tagged object identifier.

3. The electronic device of claim 1, wherein the at least one processor:
receives a plurality of object data for a first time period from the second electronic device, the plurality of object data each including an object data time stamp specifying when each of the plurality of object data was generated;
stores the plurality of object data for the first time period to the memory;
identifies a first time stamp associated with the first image;
determines if one stored object data time stamp substantially matches the first time stamp; and
in response to determining that one stored object data time stamp substantially matches the first time stamp, retrieves as the first object data, a specific one of the plurality of object data associated with the one stored object data time stamp.

4. The electronic device of claim 1, wherein the at least one processor:
determines if the first image has been selected for viewing;
in response to determining that the first image has been selected for viewing, retrieves the first image and the first meta-data corresponding to the first image;
determines if the first meta-data contains a first tagged object identifier and a first location of the first tagged object within the first image; and
in response to determining that the first meta-data contains the first tagged object identifier and the first location of the first tagged object within the first image, marks the first image with the first tagged object identifier at the first location.

5. The electronic device of claim 1, wherein the at least one processor:
detects selection of a first post capture processing parameter of the first image for modification;
generates a second post capture processing parameter of the first image at least partially based on the first meta-data; and
renders the first image based on the generated second post capture processing parameter.

6. The electronic device of claim 5, wherein the second post capture processing parameter comprises at least one of:
a zoom level;
a focal distance;
a cropping area;
an image tag;
an image effect; and
removal of an unwanted object.

7. The electronic device of claim 1, wherein the at least one processor:
retrieves at least one of a first zoom level and a first focal distance of the first image from the first meta-data;
generates at least one of a second zoom level and a second focal distance of the first image based on the first location of the first tagged object; and
adjusts at least one of the first zoom level and the first focal distance of the first image to the second zoom level and the second focal distance to focus on the first tagged object at the first location.

8. The electronic device of claim 1, wherein the at least one processor:
detects selection of an image effect for the first image;
generates at least one post capture processing parameter for the selected image effect, the generated at least one post capture processing parameter at least partially based on the selected image effect applied to the first tagged object identified by the first meta-data;
renders the first image at least partially based on the generated at least one post capture processing parameter; and
displays the rendered first image on the display.

9. The electronic device of claim 1, wherein the at least one processor:
displays the first image with a first tagged object identifier at the first location;
detects selection of the first tagged object for deletion in the first image;
removes the first tagged object from the first image;
renders the first image with the first tagged object removed; and
displays the rendered first image on the display.

10. A method comprising:
capturing, via a first camera of an electronic device, a first image within a field of view of the first camera;
receiving, via the electronic device, first object data from a second electronic device located within the field of view;
determining, via at least one processor and based on the first object data, if the first image contains a first tagged object within the field of view of the first camera;
in response to determining that the first image contains the first tagged object within the field of view, mapping, based on the first object data, the first tagged object to a first location within the first image;
generating first meta-data associated with the first image, the first meta-data containing at least the first location of the first tagged object within the first image; and
storing the first image with the first meta-data to a memory of the electronic device.

11. The method of claim 10, further comprising:
identifying, based on the first object data, a first tagged object identifier associated with the first tagged object; and
modifying the first meta-data associated with the first image, to generate modified first meta-data comprising the first tagged object identifier.

12. The method of claim 10, further comprising:
receiving a plurality of object data for a first time period from the second electronic device, each of the plurality of object data including an object data time stamp specifying when the object data was generated;
storing the plurality of object data for the first time period to the memory;
identifying a first time stamp associated with the first image;
determining if one object data time stamp substantially matches the first time stamp; and
in response to determining that one stored object data time stamp substantially matches the first time stamp, retrieving as the first object data, a specific one of the plurality of object data associated with the one stored object data time stamp.

13. The method of claim 10, further comprising:
determining if the first image has been selected for viewing;
in response to determining that the first image has been selected for viewing, retrieving the first image and the first meta-data corresponding to the first image;
determining if the first meta-data contains a first tagged object identifier and the first location of the first tagged object within the first image; and
in response to determining that the first meta-data contains the first tagged object identifier and the first location of the first tagged object within the first image, marking the first image with the first tagged object identifier at the first location.

14. The method of claim 10, further comprising:
detecting selection of a first post capture processing parameter of the first image for modification;
generating a second post capture processing parameter of the first image at least partially based on the first meta-data; and
rendering the first image based on the generated second post capture processing parameter.

15. The method of claim 14, wherein the second post capture processing parameter comprises at least one of:
a zoom level;
a focal distance;
a cropping area;
an image tag;
an image effect; and
removal of an unwanted object.

16. The method of claim 10, further comprising:
retrieving at least one of a first zoom level and a first focal distance of the first image from the first meta-data;
generating at least one of a second zoom level and a second focal distance of the first image based on the first location of the first tagged object; and
adjusting at least one of the first zoom level and the first focal distance of the first image to the second zoom level and the second focal distance to focus on the first tagged object at the first location.

17. The method of claim 10, further comprising:
detecting selection of an image effect for the first image;
generating at least one post capture processing parameter for the selected image effect, the generated at least one post capture processing parameter at least partially based on the selected image effect applied to the first tagged object identified by the first meta-data;
rendering the first image at least partially based on the generated at least one post capture processing parameter; and
displaying the rendered first image on a display.

18. The method of claim 10, further comprising:
displaying the first image with a first tagged object identifier at the first location;
detecting selection of the first tagged object for deletion in the first image;
removing the first tagged object from the first image;
rendering the first image with the first tagged object removed; and
displaying the rendered first image on a display.

19. A computer program product comprising:
a computer readable storage device having stored thereon program code which, when executed by at least one processor of an electronic device having an ultra wideband wireless communication transceiver, at least one camera, and a memory, enables the electronic device to complete functionality comprising:
capturing a first image within a field of view of a first camera among the at least one camera;
receiving first object data from a second electronic device located within the field of view;
determining, based on the first object data, if the first image contains a first tagged object within the field of view of the at least one camera;
in response to determining that the first image contains the first tagged object within the field of view, mapping, based on the first object data, the first tagged object to a first location within the first image;
generating first meta-data associated with the first image, the first meta-data containing at least the first location of the first tagged object within the first image; and
storing the first image with the first meta-data to the memory.

20. The computer program product of claim 19, wherein the program code for identifying objects in an image comprises program code that further enables the electronic device to complete the functionality of:
determining if the first image has been selected for viewing;
in response to determining that the first image has been selected for viewing, retrieving the first image and the first meta-data corresponding to the first image;
determining if the first meta-data contains a first tagged object identifier and a first location of the first tagged object within the first image; and
in response to determining that the first meta-data contains the first tagged object identifier and the first location of the first tagged object within the first image, marking the first image with the first tagged object identifier at the first location.
